(19) United States
(12) Patent Application Publication
(10) Pub. No.: US 2009/0127917 A1
(43) Pub. Date: May 21, 2009

(54) HIGH CHAIR NET ASSEMBLY

(76) Inventor: Keith Foenander, Burbank, CA (US)

Correspondence Address: CHRISTIE, PARKER & HALE, LLP, PO BOX 7068, PASADENA, CA, 91109-7068, US

(21) Appl. No.: 12/274,704

(22) Filed: Nov. 20, 2008

Related U.S. Application Data
(60) Provisional application No. 60/989,604, filed on Nov. 21, 2007.

(51) Int. Cl. A47C 31/00; B23P 11/00

(52) U.S. Cl. 297/463.1; 29/428

(57) ABSTRACT

A high chair net assembly and a method of utilizing a high chair net assembly. Embodiments of a high chair net assembly include a net, at least one coupling device configured to couple the net to a high chair, and at least one folding mechanism. A method of utilizing a high chair net assembly having a net, at least one coupling device, and at least one folding mechanism includes coupling the net to a high chair via the at least one coupling device, and unfolding the at least one folding mechanism to open the net around the high chair.

### CROSS-REFERENCE TO RELATED APPLICATION(S)

This application claims priority to and the benefit of U.S. Provisional Patent Application No. 60/989,604, filed on Nov. 21, 2007, the entire content of which is incorporated herein by reference.

### FIELD OF THE INVENTION

The present invention relates generally to high chair devices. More particularly, the present invention relates to accessories for a high chair.

### BACKGROUND OF THE INVENTION

As most parents of small children are aware, it is a common occurrence for children and toddlers seated at high chairs to drop food, utensils, toys, and other articles to the floor. Moreover, when a small child is seated at a high chair which is positioned with a table in front of it, the child will most often drop or toss the food or other articles off the side or rear of the high chair. For reasons of cleanliness and prevention of illness, most parents and guardians will not give a utensil or toy, and certainly not a child's food, back to the child after it has fallen onto the floor without having first cleaned the article. This is especially true in a restaurant, where a floor surface is less likely to be clean because of the large amount of foot traffic and potential dirt and bacteria. Furthermore, it may be more difficult to sanitize or replace a child's utensil or other article when in a restaurant.

Accordingly, it may be desirable to prevent a child's food, utensils, toys, or other articles from falling to the floor when the child is seated in a high chair.

### SUMMARY OF THE INVENTION

Aspects of embodiments of the present invention include a high chair net assembly for preventing a child's food, utensils, toys, or other articles from falling to the floor and holding such articles at a height where the child can recover them. Another aspect of embodiments of the present invention is a high chair net assembly constructed from a safe, durable, and washable material. Yet another aspect of embodiments of the present invention is a high chair net assembly that is lightweight and portable so that it can easily be carried to and used at a restaurant. Still another aspect of embodiments of the present invention is a high chair net assembly that is configured to be attached to a high chair of a type commonly found in a restaurants.

According to one embodiment, the above and other desirable aspects of the present invention may be carried out by a high chair net assembly including a net, and at least one coupling device configured to couple the net to a high chair.

In one embodiment, the high chair net assembly further includes at least one folding mechanism. In one embodiment, the at least one folding mechanism is moveable from a folded position to an unfolded position, and the net surrounds at least a portion of a periphery of the high chair when the at least one folding mechanism is in the unfolded position.

According to another embodiment, a high chair net assembly includes: a net configured to surround at least a portion of a periphery of a high chair; at least one panel configured to at least partially cover at least one side or back of the high chair; and at least one hinge assembly including a first arm and a second arm pivotably coupled to the first arm, the first arm configured to support the at least one panel and having a mechanism for attaching the at least one panel to the high chair, and the second arm configured to support the net.

According to another embodiment, a method of utilizing a high chair net assembly having a net, at least one coupling device, and at least one folding mechanism includes coupling the net to a high chair via the at least one coupling device, and unfolding the at least one folding mechanism to open the net around the high chair.

### BRIEF DESCRIPTION OF THE DRAWINGS

The above aspects, and other features and aspects, of embodiments of the present invention will become better understood with regard to the following description, appended claims, and accompanying drawings where:

FIG. 1 is a front perspective view of a high chair net assembly according to an embodiment of the present invention;

FIG. 2 is a top view of the high chair net assembly of FIG. 1;

FIG. 3 is a front view of the high chair net assembly of FIG. 1;

FIG. 4 is a front view of the high chair net assembly of FIG. 1, the high chair net assembly shown in a folded position;

FIG. 5 is a front view of a hinge of a high chair net assembly according to an embodiment of the present invention, the hinge shown in an unfolded position; and

FIG. 6 is a front view of the hinge of FIG. 5, the hinge shown in a folded position.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

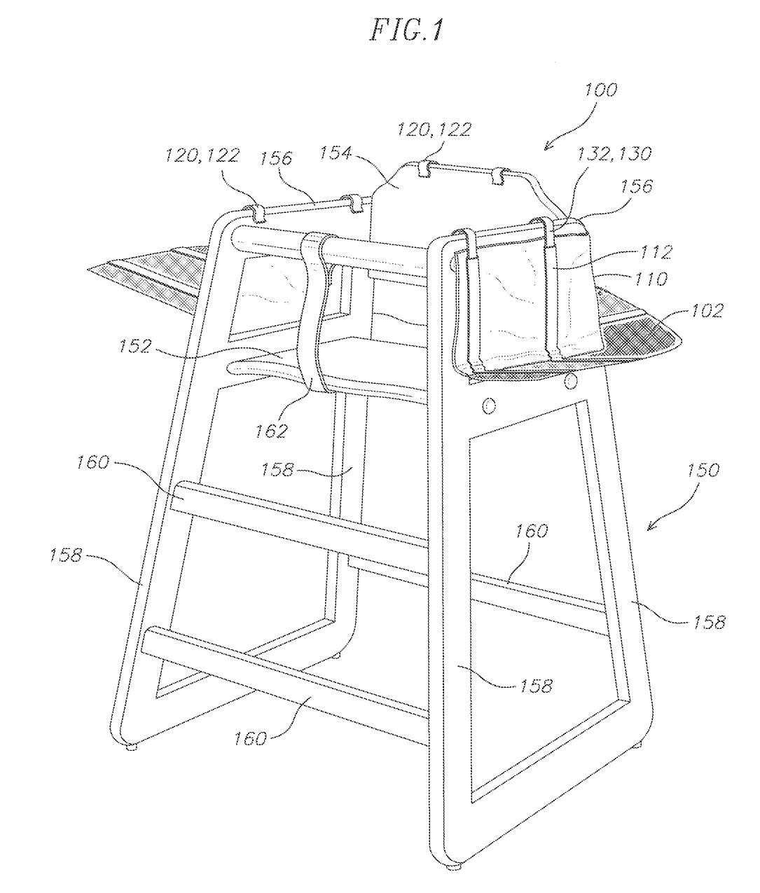

With reference to FIGS. 1-4, a high chair net assembly 100 includes a net 102. In one embodiment, the net 102 is constructed from a nylon mesh material. This material is advantageous because it is durable, lightweight, collapsible, and easily cleaned. Alternatively, the net 102 may be constructed of any other suitable material, such as cloth, cotton, or any material which is flexible and washable. Further, the net 102 may be formed from a single piece of material or from several pieces of material sewn or otherwise joined to one another.

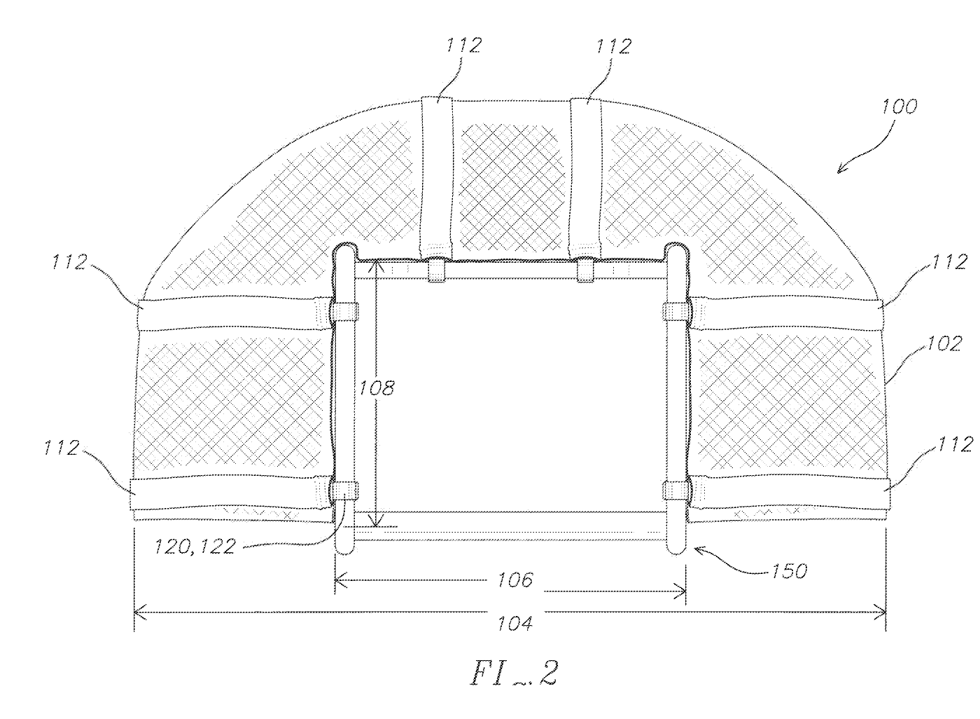

As shown in FIG. 2, in one embodiment, the net 102 has a substantially semi-circular outer shape and an inner rectangular cut-out sized to match the dimensions of a high chair. The diameter 104 of the substantially semi-circular outer edge is approximately 40 inches (102 centimeters). The substantially rectangular cutout has a width 106 of approximately 15 inches (38.1 centimeters) and a depth 108 of approximately 12 inches (30.5 centimeters). Alternatively, the net 102 may have three substantially rectangular sides joined by two substantially triangular portions, or any other suitable shape. The dimensions of the net 102 may be varied, of course, without departing from the present invention. A large net 102 will prevent more articles from falling to the floor. However, a small net 102 may be more easily used in small spaces and may be more portable.

With further reference to FIGS. 1-4, the high chair net assembly 100, in one embodiment, also includes three vertical panels 110. In one embodiment, the vertical panels 110 are formed from cloth. However, the invention is not limited thereto, and other suitable materials, including fiberglass, aluminum, wood, nylon mesh, and/or a plastic, may be used to form the vertical panels 110. While the embodiment shown includes three vertical panels 110, the high chair net assembly may alternatively include any other desired number of vertical panels 110, such as one or two. Additionally, a single vertical panel 110 having more than one side may be used instead of three separate vertical panels 110.

The vertical panels 110 have lengths that are approximately equal to the dimensions of the three corresponding sides of the substantially rectangular cutout of the net 102, described above. Further, each of the vertical panels 110, in the embodiment shown, has a height of approximately nine inches (22.8 centimeters). However, the height of the vertical panels 110 is not crucial to the invention and may be varied as desired. A greater height of the vertical panels 110 will result in the net 102 being closer to the floor. A beneficial height of the vertical panels 110, according to one embodiment, will allow a child to reach an article resting on the net 102. Additionally, one or more of the vertical panels 110 may have a different height than one or more other vertical panels 110.

As further shown in FIGS. 1-4, according to one embodiment, the high chair net assembly 100 includes six sleeves 112. In one embodiment, the sleeves 112 are formed from cloth. The material of the sleeves 112 should be a flexible material because the sleeves 112 will be folded during use. Alternatively, each sleeve 112 may be formed as two separate segments that are separated near a region where the sleeve 112 is folded. In one embodiment, the sleeves 112 are open on an end nearest the high chair. Alternatively, the sleeves 112 may be open on both ends. Also, each sleeve 112 may be formed from a single layer of material, two stacked layers of material, or a tubular segment of material.

The sleeves 112, according to one embodiment, have a length of approximately 24 inches (70 centimeters) and a width of approximately three inches (7.62 centimeters). Alternatively, the length and the width of the sleeves 112 may be varied, so long as a supporting member can be inserted into each sleeve 112. Also, although the shown embodiment of the high chair net assembly 100 includes six sleeves 112, the high chair net assembly may include any other suitable number of sleeves 112.

With further reference to FIGS. 1-4, the high chair net assembly 100 includes one or more attachment members 120 configured to attach the net 102 to a high chair. In the embodiment shown in FIGS. 1-4, the attachment members 120 include six hooks 122. In one embodiment, the hooks 122 are constructed from a plastic material, providing durability, light weight, and low cost. Further, because the hooks 122 will extend to an inner region of the high chair, a plastic material may also provide for safe handling if a child touches the hooks 122. The hooks 122 may alternatively be constructed from any other suitable material, such as aluminum, fiberglass, or wood.

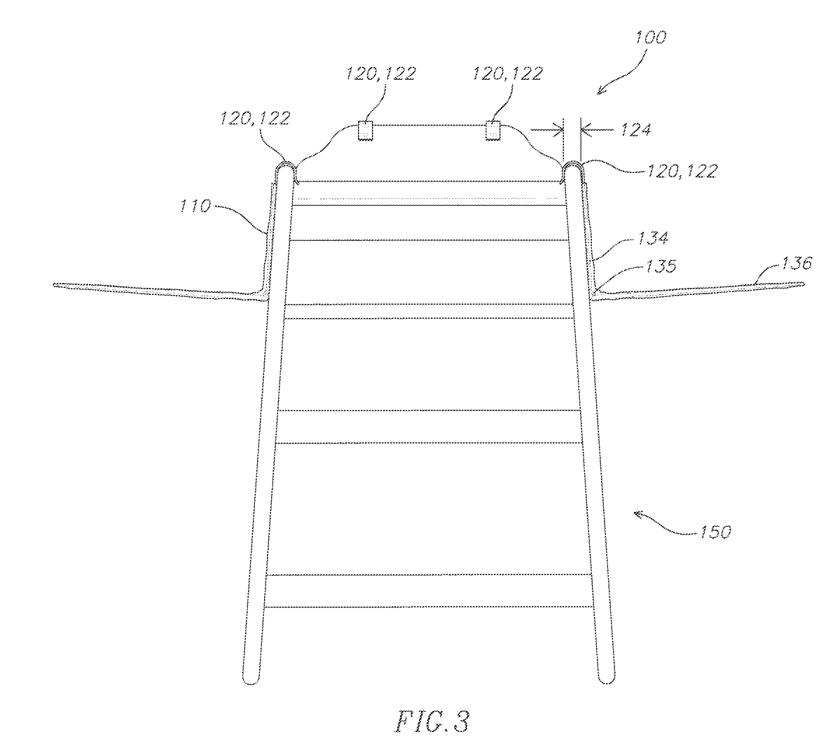

According to one embodiment, a width 124 of each of the hooks 122 (i.e. the distance between the two opposite faces), as shown in FIG. 3, is slightly greater than the thickness of a component of a high chair over which the hooks 122 are placed. In one embodiment, the width 124 of the hooks 122 is approximately one inch (2.54 centimeters), such that the hooks fit snugly over a side rail or back of a typical restaurant-style high chair. Additionally, by constructing the hooks 122 from a material with some elasticity, such as a plastic material, the width 124 can be increased during use to fit more snugly over a component of a high chair.

As an alternative to the hooks 122, the attachment members 120 may include any other device known in the art that is suitable for attaching a net to a high chair. For example, the attachment members 120 may include straps, which may, in turn, include hook-and-loop fasteners. Alternatively, the attachment members 120 may include clamps, magnets, set screws, and/or any other suitable device or combination thereof.

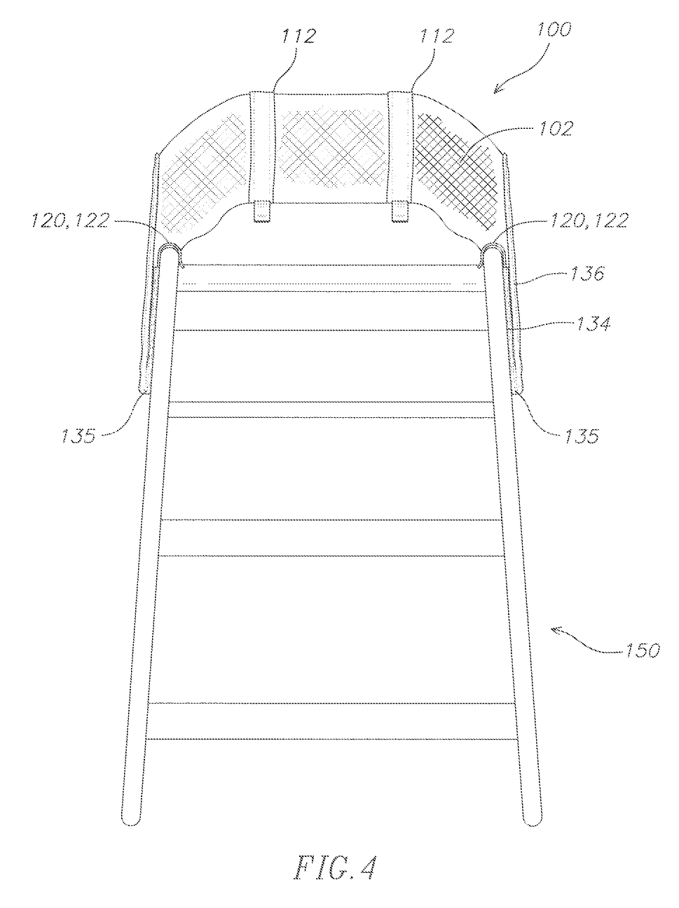

With further reference to FIGS. 1-4, according to one embodiment, the high chair net assembly 100 also includes one or more folding mechanisms 130. FIGS. 1-3 show the high chair net assembly 100 in an unfolded (i.e. opened) position. By contrast, FIG. 4 shows the high chair net assembly 100 in a folded (i.e. closed) position. In the embodiment shown in FIGS. 1-4, the high chair net assembly 100 includes six folding mechanisms 130, the six folding mechanisms 130 embodied by six hinges 132.

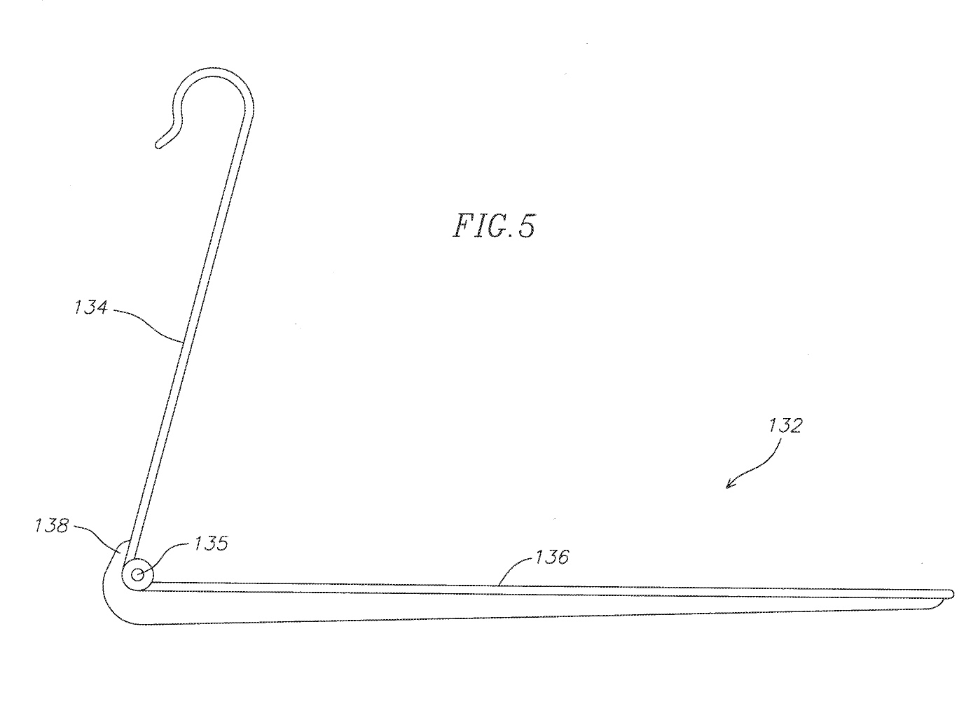

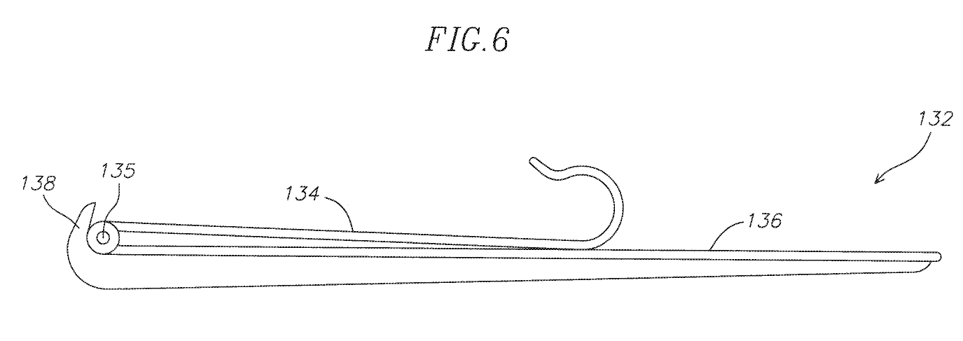

The hinges 132 are shown in greater detail in FIGS. 5 and 6. FIG. 5 shows one of the hinges 132 in an unfolded position, while FIG. 6 shows one of the hinges 132 in a folded position. In one embodiment, the hinges 132 are constructed from a plastic material, providing durability, light weight, and low cost. Alternatively, the hinges 132 may be constructed from any other suitable material, such as aluminum, wood, or fiberglass.

As shown in FIGS. 5 and 6, each of the hinges 132 includes a stationary arm 134, a pivot 135, and an extending arm 136. The extending arm 136 is pivotably, or rotatably, coupled to the stationary arm 134 at the pivot 135. In one embodiment, the stationary arms 134 have a length of approximately 8 inches (20.3 centimeters) and a width of approximately 1.5 inches (3.8 centimeters). The extending arms 136, in one embodiment, have a length of approximately 10 inches (25.4 centimeters) and a width of approximately 1.5 inches (3.8 centimeters). The widths of the stationary arms 134 and the extending arms 136 are less than the widths of the sleeves 112.

Of course, the lengths of the stationary arms 134 and extending arms 136 may vary in alternative embodiments. In one embodiment, the length of the stationary arms 134 should be approximately equal to the height of the vertical panels 110. As described above, a greater height of the vertical panels 110 will result in the net 102 being closer to the floor. Also, as described above regarding the heights of the vertical panels 110, the stationary arms 134 may have lengths that vary from one another. For example, if a back of a high chair is at a higher elevation than are sides of the high chair, stationary arms 134 for use with the back may be longer than stationary arms 134 for use with the sides of the high chair. Longer extending arms 136 will result in the net 102 protruding a greater distance from a high chair.

In one embodiment, the end of each extending arm 136 located at the pivot 135 has a stop 138. Each stop 138 has a face which butts against the side of the stationary arm 134 opposite the pivot 135. The angle of the face of the stop 138 controls the maximum angle to which the extending arm 136 will open relative to the corresponding stationary arm 134. In one embodiment, an angle of approximately 75 degrees is used, but any angle of 90 degrees or less may be used. A smaller angle will result in the ends of the extending arms 136 and the net 102 being closer to a high chair.

The high chair net assembly 100 is configured to be used with a high chair 150. The high chair 150, in one embodiment, is of a style commonly used in restaurants for toddlers and small children. As shown in FIG. 1, the high chair 150 has a seat 152 and a back 154. The high chair 150 also has two side rails 156 at or near the top of the high chair 150 which extend from a front to the back 154 of the high chair 150. Additionally, the high chair 150 has four legs 158 which may be connected by one or more structural beams 160. As shown in FIG. 1, the high chair 150 may also include a restraint 162 to keep the child or toddler from falling. The high chair 150 is commonly made from wood, but may also be constructed from aluminum, plastic, or another material or combination thereof.

In assembly, the components of the high chair net assembly 100 described above and shown in FIGS. 1-6 may be connected to each other in any suitable manner or combination thereof. In one embodiment, for example, each of the vertical panels 110 is sewn to the net 102. The seam along which the net 102 and each of the vertical panels 110 is connected should remain flexible because this is the region where the high chair net assembly 100 is folded and unfolded. Also, in one embodiment, each of the sleeves 112 is sewn partially to one of the vertical panels 110 and partially to the net 102. Two of the sleeves 112 are connected to each of the vertical panels 110, one of the sleeves 112 being located near each end of each of the vertical panels 110. The sleeves 112 are folded at an angle where the net 102 is connected to the vertical panels 110.

In one embodiment, the stationary arms 134 and the extending arms 136 of the hinges 132 are inserted into the sleeves 112. As a result of this configuration, the extending arms 136 support the net 102 because the sleeves 112 are connected to the net 102. Also, as shown in FIGS. 1-3, when the hinges 132 are in an unfolded position, the net 102 will also have an unfolded shape. Furthermore, by inserting the stationary arms 134 into the sleeves 112, the vertical panels 110, to which the sleeves 112 are connected, will hold their shape even where formed from a flexible material, such as a cloth.

Further, in assembly, one or more of the attachment members 120 may be combined with one or more of the folding mechanisms 130. For example, in the embodiment shown in FIGS. 5 and 6, one of the hooks 122 and one of the hinges 132 are constructed as a unitary device by forming the hook 122 at the end of the stationary arm 134 of the hinge 132 opposite the end of the stationary arm 134 connected to the extending arm 136. Alternatively, two or more of the hooks 122 may be combined with one of the hinges 132, or vice versa.

In use, according to one embodiment, the high chair net assembly 100 is first attached to the high chair 150 via the one or more attachment members 120. With reference to FIG. 4, according to one embodiment, the high chair net assembly 100 is attached to the high chair 150 by placing the hooks 122 onto the two side rails 156 and the back 154 of the high chair 150. In one embodiment, two of the hooks 122 are attached to each side rail 156 and two of the hooks 122 are attached to the back 154 of the high chair 150.

After the high chair net assembly 100 has been attached to the high chair 150, the high chair net assembly 100 may be opened by unfolding the one or more folding mechanisms 130. As shown in FIGS. 1-3, when the hinges 132 are opened by moving the extending arms 136 of the hinges 132 away from the stationary arms 134 via the pivots 135, the extending arms 136 will also move the sleeves 112 and thereby open the net 102. Due to the angle of the stops 138, the extending arms 136, and therefore the net 102 as well, will open to an angle of approximately 75 degrees relative to the side rails 136 and the back 134 of the high chair 150. This is beneficial because when the net 102 is supported at an angle of less than 90 degrees relative to the side rails 136 and the back 134 of the high chair 150, articles dropped by a child and caught by the net 102 will likely come to rest in an area of the net 102 near the high chair 150, where the articles will be within the child's reach.

Use of the high chair net assembly 100 has been described above by performing the attaching task before the unfolding task. However, the high chair net assembly 100 may also be utilized by first unfolding the high chair net assembly 100, and subsequently attaching the high chair net assembly 100 to a high chair.

Although embodiments of the present invention have been described with reference to a restaurant-style high chair of a type described above and depicted in FIGS. 1-4, it will be appreciated by individuals skilled in the art that the high chair net assembly 100 according to embodiments of the present invention can be used with other types of high chairs that are known in the art.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the claims supported by this application and their equivalents, rather than the foregoing description.

What is claimed is:

1. A high chair net assembly comprising a net, and at least one coupling device configured to couple the net to a high chair.

2. The high chair net assembly of claim 1, wherein the at least one coupling device comprises at least one hook.

3. The high chair net assembly of claim 2, wherein the at least one hook comprises a plastic material.

4. The high chair net assembly of claim 1, wherein the at least one coupling device comprises at least one strap.

5. The high chair net assembly of claim 4, wherein the at least one strap comprises at least one hook-and-loop fastening device.

6. The high chair net assembly of claim 1, further comprising at least one folding mechanism.

7. The high chair net assembly of claim 6, wherein the at least one folding mechanism comprises at least one hinge.

8. The high chair net assembly of claim 6, wherein the at least one folding mechanism is moveable from a folded position to an unfolded position, and the net surrounds at least a portion of a periphery of the high chair when the at least one folding mechanism is in the unfolded position.

9. The high chair net assembly of claim 1, wherein the net comprises a nylon mesh.

10. A high chair net assembly comprising:
a net configured to surround at least a portion of a periphery of a high chair;
at least one panel configured to at least partially cover at least one side or back of the high chair; and
at least one hinge assembly comprising a first arm and a second arm pivotably coupled to the first arm, the first arm configured to support the at least one panel and having a mechanism for attaching the at least one panel to the high chair, and the second arm configured to support the net.

11. A method of utilizing a high chair net assembly having a net, at least one coupling device, and at least one folding mechanism, the method comprising coupling the net to a high chair via the at least one coupling device, and unfolding the at least one folding mechanism to open the net around the high chair.
